(19) United States
(12) Patent Application Publication
(10) Pub. No.: US 2008/0253503 A1
(43) Pub. Date: Oct. 16, 2008

(54) Ct-Imaging System

(75) Inventor: Roland Proksa, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/067,183

(22) PCT Filed: Sep. 12, 2006
(86) PCT No.: PCT/IB2006/053223

§ 371 Date: Mar. 18, 2008

(30) Foreign Application Priority Data
Sep. 22, 2005 (EP) 05108745.0

(51) Int. Cl. H05G 1/46

(52) U.S. Cl. 378/5

(57) ABSTRACT

The present invention relates to a CT imaging system for imaging a substance, such as a contrast agent, present an object of interest, such as a patient. To provide a CT imaging system that involves limited technical efforts and costs but leads to a contrast enhancement and allows the imaging of a substance in object of interest, a CT imaging system is proposed comprising: a polychromatic X-ray source (2) for emitting polychromatic X-ray radiation (4), an energy-resolving X-ray detector (6) for detecting that X-ray radiation (4) after passing through said object and for providing a plurality of energy-resolved detection signals (dᵢ) for a plurality of energy bins (bᵢ), a calculation unit (12) for determining the k-edge component (k) of said substance by solving a system of equations for said plurality of energy-resolved detection signals (dᵢ), using a model for said detection signals (dᵢ) describing a detection signal as a combination of the k-edge effect of said substance, the photo-electric effect and the Compton effect, each effect contributing with a corresponding component (p, c, k) to said detection signal, and a reconstruction unit (13) for reconstructing a k-edge image of said substance from the calculated k-edge components (k) of said substance obtained for different detector positions. The invention relates further to a corresponding image processing device and method.

The present invention relates to a CT imaging system for imaging a substance present in an object of interest. Further, the present invention relates to an image processing device for use in such a CT imaging system and to a corresponding image processing method. Still further, the present invention relates to a computer program for implementing said image processing method on a computer.

Conventional CT (Computed Tomography) imaging systems measure the X-ray attenuation and provide limited contrast for medical imaging. Most clinical applications use contrast agents to enhance the contrast. However, it would be desired to extend the information contents of CT imaging systems.

There are two well-known techniques to extent the contrast of CT imaging. A first technique is the so-called dual-energy CT imaging technique, which is, for instance, described in Kalender, W. A. et al., “Evaluation of a prototype dual-energy computed tomographic apparatus. I. Phantom Studies”, Medical Physics, Vol. 13, No. 3, May/June 1986, pp. 334-339. Dual-energy CT is capable to measure two energy dependent base functions such as the photo-electric effect and the Compton scatter component. It is possible to use different base functions, but the images are always composed of a virtual linear combination of the two components.

A second technique is k-edge imaging in which a tunable, monochromatic source is used for detection of specific atoms by measuring the attenuation at two or more energies, generally before and behind the k-edge, which is, for instance, described in H. Elleaune, A. M. Charvet, S. Corde, F. Esteve and J. F. Le Bas, “Performance of computed tomography for contrast agent concentration measurements with monochromatic x-ray beams: comparison of K-edge versus temporal subtraction”, Phys. Med. Biol. 47 (2002), 3369-3385. However, monochromatic sources are not suitable for clinical applications since they either have power levels far away from the required power for medical imaging or since they use synchrotron radiation of high energy accelerators.

Mainly due to the limited contrast enhancement and/or the high technical efforts and costs, these known techniques are therefore not used in clinical practice. It is thus an object of the present invention to provide a CT imaging system involving less technical efforts and costs but leading to a larger contrast enhancement and allowing the imaging of a substance present in an object of interest, such as specific atoms (e.g. a contrast agent). Further, a corresponding image processing device and image processing method shall be provided.

The object is achieved according to the present invention by a CT imaging system as defined in claim 1 comprising:

a polychromatic X-ray source for emitting polychromatic X-ray radiation,

an energy-resolving X-ray detector for detecting that X-ray radiation after passing through said object and for providing a plurality of energy-resolved detection signals for a plurality of energy bins,

a calculation unit for determining the k-edge component of said substance by solving a system of equations for said plurality of energy-resolved detection signals, using a model for said detection signals describing a detection signal as a combination of the k-edge effect of said substance, the photo-electric effect and the Compton effect, each effect contributing with a corresponding component to said detection signal, and

a reconstruction unit for reconstructing a k-edge image of said substance from the calculated k-edge components of said substance obtained for different detector positions.

An appropriate image processing device for use in such a CT imaging system and a corresponding image processing method are defined in claims 8 and 9. A computer program, which may be stored on a record carrier, for implementing said image processing method on a computer is defined in claim 10. Preferred embodiments of the invention are defined in the dependent claims.

The present invention is based on the idea to use a conventional polychromatic X-ray source and an energy-resolving X-ray detector which will probably be available in the near future. With proper processing of the acquired data it is then possible to reconstruct at least three images with the substance component (e.g. contrast agent component), the photo-effect component excluding the substance component and the Compton scatter component excluding the substance component. In particular, the X-ray detector provides a number of energy-resolved detection signals with spectral sensitivity for different energy bins, an energy bin being a section of the complete energy range in which said detection signal is available and of interest. The scanned object is then modeled as a combination of the photo-electric effect with a first spectrum, the Compton effect with a second spectrum and the substance with a k-edge in the interesting energy range with a third spectrum. The density length product for each of the components in each detection signal is modeled as a discrete linear system which is solved to obtain at least the k-edge components of said substance. From the k-edge components of said substance obtained for different detector positions a k-edge image of the substance can then be reconstructed with a conventional reconstruction method.

Energy-resolving X-ray detectors are currently in development and will be available in the near future. They are generally working on the principle to count the incident photons and to output a signal that shows the number of photons in a certain energy range. Such an energy-resolving detector is, for instance, described in Llopart, X., et al. “First test measurements of a 64 k pixel readout chip working in a single photon counting mode”, Nucl. Inst. and Meth. A, 509 (1-3): 157-163, 2003 and in Llopart, X., et al., “Medipix2: A 64-k pixel readout chip with 55 mum square elements working in a single photon counting mode”, IEEE Trans. Nucl. Sci. 49(5): 2279-2283, 2002. Preferably, the energy-resolving detector is adapted such that it provides at least three energy resolved detection signals for at least three different energy bins. However, it is advantageous to have an even higher energy resolution in order to enhance the sensitivity and noise robustness of the CT imaging system.

The system of equations for said plurality of energy resolved detection signals is preferably solved by use of numerical methods. A preferred method is a maximum likelihood approach that takes the noise statistics of the measurements into account.

In a further preferred embodiment a model is used which takes account of the emission spectrum of the X-ray source and the spectral sensitivity of the X-ray detector in each of the plurality of energy bins. This leads to higher accuracy of the calculated components and, thus, of the reconstructed images.

Preferably, the CT imaging system according to the present invention is used for the direct measurement of a contrast medium, such as a contrast agent used in medical imaging. This opens a number of new clinical features to CT imaging such as absolute blood volume measurement or cerebral perfusion imaging. It can enhance the contrast for angiography and allow the discrimination of the contrast agent filled lumen and calcified plaque within a vessel. Preferred contrast agents contain, for instance, iodine or, even more preferred due to a k-edge effect at a higher energy, gadolinium. The invention can further be applied in molecular imaging to reconstruct images showing a special substance, such as a special contrast agent, injected into a patient which only docks to certain cells or other targets, such as tumor cells or fibrin. The method according to the invention thus helps or can be used for quantitative measurements of such cells within a region of interest.

Besides a k-edge image it is further preferred in another embodiment that also a photo-effect image and/or a Compton effect image are reconstructed by use of the photo-electric effect component and the Compton effect component which can be determined as well by solving the above mentioned system of equations.

The invention will now be described in more detail with reference to the drawings in which

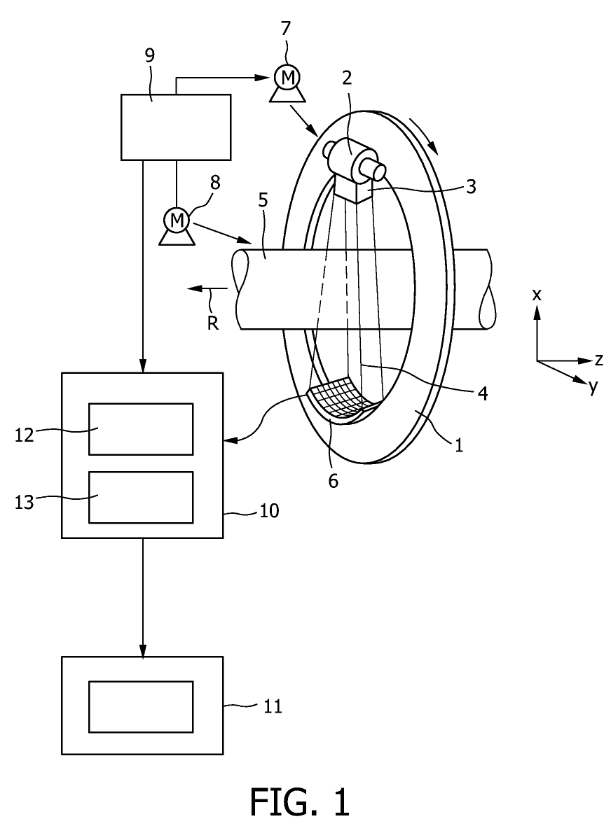

FIG. 1 shows a diagrammatic representation of a CT system in accordance with the invention,

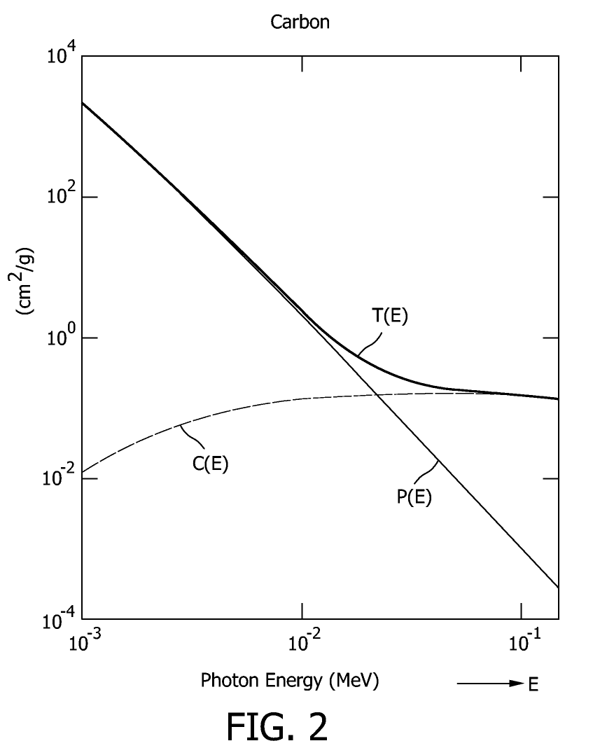

FIG. 2 shows an example of the linear attenuation coefficient over photon energy for the photo-electric effect and the Compton effect for Carbon,

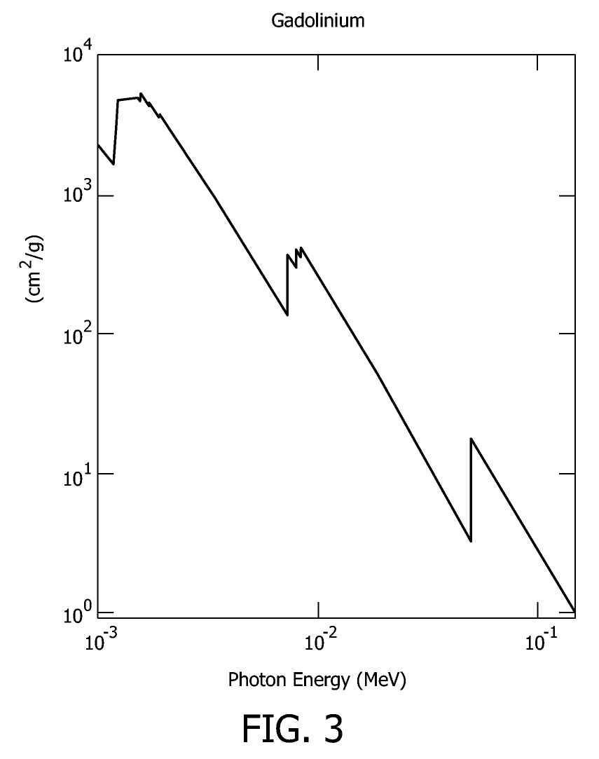

FIG. 3 shows an example of the linear attenuation coefficient over photon energy for the photo-electric effect including the k-edge effect for Gadolinium,

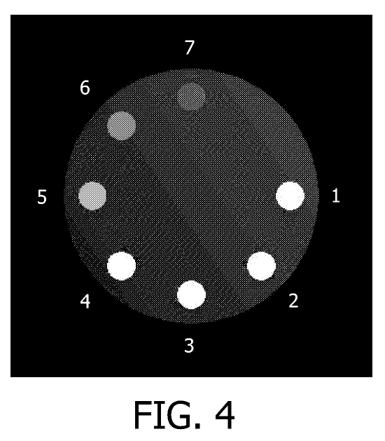

FIG. 4 shows a mathematical phantom used for a simulation, and

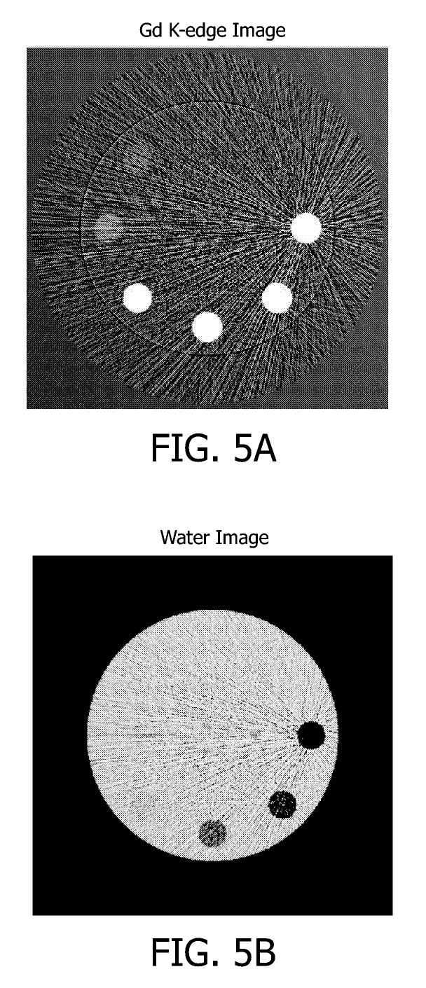

FIG. 5 shows simulation results obtained using the phantom shown in FIG. 4.

The CT system shown in FIG. 1 includes a gantry which is capable of rotation about an axis of rotation R which extends parallel to the z direction. The radiation source 2, for example an X-ray tube, is mounted on the gantry 1. The X-ray source is provided with a collimator device 3 which forms a conical radiation beam 4 from the radiation produced by the X-ray source 2. The radiation traverses an object (not shown), such as a patient, in a region of interest in a cylindrical examination zone 5. After having traversed the examination zone 5, the X-ray beam 4 is incident on an energy-resolving X-ray detector unit 6, in this embodiment a two-dimensional detector, which is mounted on the gantry 1.

The gantry 1 is driven at a preferably constant but adjustable angular speed by a motor 7. A further motor 8 is provided for displacing the object, e.g. the patient who is arranged on a patient table in the examination zone 5, parallel to the direction of the axis of rotation R or the z axis. These motors 7, 8 are controlled by a control unit 9, for instance such that the radiation source 2 and the examination zone 5 move relative to one another along a helical trajectory. However, it is also possible that the object or the examination zone 5 is not moved, but that only the X-ray source 2 is rotated.

The data acquired by the detector 6 are provided to an image processing device 10 for image processing, in particular for reconstruction of a k-edge image of a substance, such as a contrast agent, in the object (e.g. the patient). Such a k-edge image is desired in clinical practice since it carries particular information and shows a high contrast in medical images and thus allows certain desired applications. The reconstructed image can finally be provided to a display 11 for displaying the image. Also the image processing device is preferably controlled by the control unit 9.

In the following, the image processing as proposed according to the present invention shall be explained in more detail. The input to the image processing device 10 are energy-resolved detection signals dᵢ for a plurality, at minimum three, energy bins. These detection signals dᵢ show a spectral sensitivity Dᵢ (E) of the i-th energy bin bᵢ. Furthermore, the emission spectrum T (E) of the polychromatic X-ray tube 2 is generally known. In the image processing device, in particular in a calculation unit 12 the scanned object is then modeled as a linear combination of the photo-electric effect with spectrum P(E), the Compton effect with spectrum C(E) and the substance (e.g. contrast medium) with a k-edge in the interesting energy range and spectrum K(E).

Spectra P(E), C(E) and T(E) for Carbon are exemplarily shown in FIG. 2. The energy-dependent spectrum including k-edges of Gadolinium is shown in FIG. 3. The density length product for each of the components, in particular the photo-effect component p, the Compton-effect component c and the k-edge component k, in each detection signal dᵢ is thus modeled in a discrete linear system as

dᵢ=∫dE T(E)Dᵢ(E) (p P(E)+c C(E)+k K(E)).

Since at least three detection signals dᵢ-d₃ are available for the at least three energy bins b₁-b₃ a system of at least three equations is formed having three unknowns which can thus be solved with known numerical methods in a calculation unit 12. If more than three energy bins are available, it is preferred to use a maximum likelihood approach that takes the noise statistics of the measurements into account. The results, in particular the components p, c and k, can then be used in a reconstruction unit 13 to reconstruct a desired component image with conventional reconstruction methods, in particular for reconstructing a k-edge image.

Generally, three energy bins are sufficient. In order to increase the sensitivity and noise robustness, however, it is preferred to have a high energy resolution, i.e. to have more detection signals for more energy bins.

FIG. 4 shows a mathematical phantom used for a simulation. The phantom comprises a cylinder filled with water. The cylinder comprises seven smaller cylinders having different concentrations of a contrast agent (gadodiamide C₁₆H₃₁GdN₅O₈, having a molecular weight of approximately 578.7 g/mol). Using this phantom a computer simulation of a spectral CT measurement has been made. The obtained data have been processed in accordance with the method of the present invention. Results are shown in FIG. 5.

FIG. 5A shows a k-edge image for Gd. FIG. 5B shows a computed water image which should only show water. As can be seen from FIG. 5A, despite the artefacts the k-edge image shows quite correctly the different concentrations of the contrast agent in the small cylinders. The different grey values in the small cylinders of the water image (FIG. 5B) show the remaining water portion which has not been displaced by the contrast agent.

The present invention allows a direct measurement of a contrast medium injected into a patient. Many different applications in clinical practise, as explained above, are thus possible without the need for high technical efforts, such as a monochromatic X-ray source.

1. A CT imaging system for imaging a substance present in an object of interest, comprising:
a polychromatic X-ray source for emitting polychromatic X-ray radiation,
an energy-resolving X-ray detector for detecting that X-ray radiation after passing through said object and for providing a plurality of energy-resolved detection signals for a plurality of energy bins,
a calculation unit for determining the k-edge component of said substance by solving a system of equations for said plurality of energy-resolved detection signals, using a model for said detection signals describing a detection signal as a combination of the k-edge effect of said substance, the photo-electric effect and the Compton effect, each effect contributing with a corresponding component to said detection signal, and
a reconstruction unit (for reconstructing a k-edge image of said substance from the calculated k-edge components (of said substance obtained for different detector positions.

2. The CT imaging system as claimed in claim 1, wherein said energy-resolving detector is adapted for providing at least three energy-resolved detection signals for at least three different energy bins.

3. The CT imaging system as claimed in claim 1, wherein said calculation unit is adapted for using a numerical method, for solving said system of equations.

4. The CT imaging system as claimed in claim 1, wherein said calculation unit is adapted for using a model which takes account of the emission spectrum of said X-ray source and the spectral sensitivity of said X-ray detector in each of said plurality of energy bins.

5. The CT imaging system as claimed in claim 1, wherein said substance is a contrast agent injected into said object of interest.

6. The CT imaging system as claimed in claim 5, wherein said contrast agent contains iodine or gadolinium

7. The CT imaging system as claimed in claim 1,
wherein said calculation unit His adapted for determining the photo-electric effect component and/or the Compton effect component by solving said system of equations for said plurality of energy resolved detection signals, and
wherein said reconstruction unit His adapted for reconstructing a photo-electric effect image and/or a Compton effect image from the calculated photo-electric effect components and/or said Compton effect components obtained for different detector positions.

8. An image processing device for use in a CT imaging system for imaging a substance present in an object of interest, said image processing device being provided with a plurality of energy-resolved detection signals for a plurality of energy bins, said detection signals being obtained by an energy-resolving X-ray detector for detecting polychromatic X-ray radiation emitted a polychromatic X-ray source after passing through said object, comprising:
a calculation unit for determining the k-edge component of said substance by solving a system of equations for said plurality of energy-resolved detection signals, using a model for said detection signals describing a detection signal as a combination of the k-edge effect of said substance, the photo-electric effect and the Compton effect, each effect contributing with a corresponding component to said detection signal, and
a reconstruction unit for reconstructing a k-edge image of said substance from the calculated k-edge components of said substance obtained for different detector positions.

9. An image processing method for use in a CT imaging system for imaging a substance present in an object of interest, said image processing method being provided with a plurality of energy-resolved detection signals for a plurality of energy bins, said detection signals being obtained by an energy-resolving X-ray detector for detecting polychromatic X-ray radiation emitted a polychromatic X-ray source after passing through said object, comprising the steps of:
determining the k-edge component of said substance by solving a system of equations for said plurality of energy-resolved detection signals, using a model for said detection signals describing a detection signal as a combination of the k-edge effect of said substance, the photo-electric effect and the Compton effect, each effect contributing with a corresponding component to said detection signal, and
reconstructing a k-edge image of said substance from the calculated k-edge components of said substance obtained for different detector positions.

10. A Computer program comprising program code means for causing a computer to carry out the steps of the method as claimed in claim 9 when said computer program is run on a computer.
